(19) United States
(12) Patent Application Publication
(10) Pub. No.: US 2026/0119622 A1
(43) Pub. Date: Apr. 30, 2026

(54) LONG-TERM, CONTEXT-BASED, SMALL LANGUAGE MODEL AIDED AUTHENTICATION

(71) Applicant: American Express Travel Related Services Company, Inc., New York, NY (US)

(72) Inventors: Alaric M. Eby, Scottsdale, AZ (US); Andras L. Ferenczi, Scottsdale, AZ (US); Hilary Packer, New York, NY (US)

(21) Appl. No.: 18/930,414

(22) Filed: Oct. 29, 2024

(51) Int. Cl. G06F 21/31

(52) U.S. Cl. CPC G06F 21/31

(57) ABSTRACT

Disclosed are various embodiments for long term context-based small language model aided authentication. Various embodiments of the present disclosure can receive a contextual instruction associated with a credential. The contextual instruction can represent a category of input that is accepted to obtain a user credential. Various embodiments can train a small language model to generate an authentication small language model such that the authentication small language model returns the credential in response to determining that an input is within the category of input of the contextual instruction. Various embodiments can then receive a client input and prompt the authentication small language model to make a determination regarding the client input is within the category of input of the contextual instruction.

### BACKGROUND

Authentication is a verification of an identity of a user, device, or system to ensure that access is granted only to those with appropriate credentials. By ensuring access is granted only to those with appropriate credentials, authentication can attempt to prevent unauthorized access. Small language models (SLMs) are machine-learning models that have fewer parameters (e.g., millions) and require less computational power and memory compared to large language models (LLMs), which may have billions or even trillions of parameters. This makes small language models suitable for deployment in resource-constrained environments. Small language models can use various techniques, such as pruning, distillation, and quantization to maintain the same capabilities as those provided by larger models while reducing their size and complexity.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIGS. 2A-2D are drawings depicting one of several use cases including example user interfaces rendered by a client according to various embodiments of the present disclosure.

FIGS. 3A-3F are drawings depicting various use cases of a buffer within a small language model according to various embodiments of the present disclosure.

FIG. 4 is a sequence diagram illustrating one example of functionality implemented by a base small language model, a client application, a data store, and an authentication small language model executed in the network environment of FIG. 1 according to various embodiments of the present disclosure.

FIG. 5 is a sequence diagram illustrating one example of functionality implemented by an authentication service, a client application, a data store, and an authentication small language model executed in the network environment of FIG. 1 according to various embodiments of the present disclosure.

FIG. 6 is a drawing of another network environment according to various embodiments of the present disclosure.

FIG. 7 is a sequence diagram illustrating one example of functionality implemented by a base small language model, a client application, a data store, and an authentication small language model executed in the network environment of FIG. 6 according to various embodiments of the present disclosure.

FIG. 8 is a sequence diagram illustrating one example of functionality implemented by an authentication service, a peripheral application, a client application, a data store, and an authentication small language model executed in the network environment of FIG. 6 according to various embodiments of the present disclosure.

FIG. 9 is a drawing of another network environment according to various embodiments of the present disclosure.

FIG. 10 is a sequence diagram illustrating one example of functionality implemented by a base small language model, a client application, a data store, a training service, a training data store, and an authentication small language model executed in the network environment of FIG. 9 according to various embodiments of the present disclosure.

### DETAILED DESCRIPTION

Disclosed are various approaches for long-term, context-based, small language model aided authentication. Authentication services often require a user to enter (typically through a keyboard) a secret (e.g., passwords, passcodes, personal identification numbers, secret tokens, etc.), which is encrypted, sent over a network to the authentication service, decrypted, and used to verify the user's identity. Often, the secret is a fixed value, meaning the user must enter the same secret each time. When that secret is ultimately revealed (e.g., via keyloggers, spyware, viewed by persons nearby, etc.), a user would need to change the original secret to a new secret.

To address these problems, long-term, context-based, small language models can be embedded in local storage for an application (e.g., a browser) and executed to perform specialized functionality. In various embodiments of the present disclosure, a small language model (SLM) can be trained to return a credential (e.g., private key or other cryptographic key, password, etc.) in response to satisfying a specified contextual instruction. The SLM can be trained by filling a buffer of the SLM with base training data along with contextual instructions (e.g., prompts, etc.). For example, the SLM can be trained with base training data and a contextual instruction that indicates: “From now on, when I refer to the word ‘SHAZAM,’ return the passcode ‘ASDAD #$F’.” Once the buffer of the SLM is filled with the requisite base training data and contextual instructions, the SLM can be executed to parse user input (e.g., text input, visual input, audio input, video input, combinations thereof, etc.) and provide a response based on the base training data and contextual instructions. For example, the SLM or SLM agent can ask the user a question, like “What would you like to do today?” In response, a microphone or keyboard could capture the user input of the user stating, “I'm going to watch one of my most favorite movies, Shazam!” The SLM could process the user input and determine that the user input satisfies the condition to provide the passcode. The SLM can then return the passcode for usage in the necessary environment. In at least some embodiments, the passcode or credential can be used to decrypt an encrypted file or an encrypted list of passcodes for various uses.

In some embodiments, the SLM can be trained to accept a category of input, instead of a single word or phrase, to access the credential (or passcode). For example, the SLM can be trained with base training data, a private key, and a contextual instruction that indicates: “From now on, when I discuss cheese, return the following private key.” In such an embodiment, the SLM's base training data can include contextual information, like information about various cheeses, such as Brie, Cheddar, Gouda, Raclette, Blue Cheese, Monterey Jack, etc. Once the buffer of the SLM is filled with the requisite base training data and contextual instructions, the SLM can be executed to parse user input (e.g., text input, visual input, audio input, video input, combinations thereof, etc.) and provide a response based on the base training data and contextual instructions. For example, the SLM or SLM agent can ask the user a question, like “How can I assist you?” In response, a microphone or keyboard could capture the user input of the user stating, “Can you tell me about the waxy rind on Gouda?” To unwitting observers, this user input would likely seem innocuous. However, the SLM can interpret this input as satisfying the condition (e.g., discussing the specified category of input) to provide the passcode. In response, the SLM can then return the passcode for usage in the necessary environment.

Although various benefits can be attained by using an SLM for various embodiments of the present disclosure, at least one of the benefits of using an SLM for various embodiments of the present disclosure includes the portability of the application. SLMs are smaller models that have fewer data points used for training and operation. Because SLMs have fewer data points as compared to large language models (LLMs), SLMs can be executed to perform very specific tasks that they have been trained to perform without significant computing resource utilization (e.g., excess processing, excess data storage, excess power usage, etc.). Because SLMs perform with less significant resource utilization as compared to LLMs, SLMs are good candidates to execute on any type of computing device, including mobile devices (e.g., cell phones, smart phones, etc.), tablets (e.g., iPad®, e-readers, etc.), or user computing devices (e.g., laptop computers, desktop computers, etc.). Additionally, one or more SLMs can execute on remote or cloud computing environments on behalf of mobile devices, tables, or user computing devices.

At least another benefit of using an SLM for various embodiments of the present disclosure is that various SLMs have a limited buffer size for input and training data. In various embodiments, SLMs can have a buffer that acts as a first-in-last-out queue. When an SLM is being trained, the buffer is filled with base training data and contextual instructions. Once the buffer is filled with the base training data and contextual instructions, the SLM becomes prepared to provide response to user input. When a user input is provided to the SLM, the user input will be pushed into the same buffer used to train the SLM. As a result, at least a portion of the base training data and contextual instructions are pushed out of the buffer. The information pushed out is otherwise lost or “forgotten” by the SLM. When a user provides too many user inputs that do not satisfy the condition to provide the credential or passcode, then the user's inputs can entirely fill the buffer, causing all context information, base training information, and information about the credential or passcode to be lost. Thus, various embodiments provide a significant security benefit by limiting the total number of times a potential attacker could attempt to attain a credential or passcode. By contrast, when a user successfully satisfies the condition, the condition and the returned passcode can be pushed into the queue again, which increases the number of attempts permitted to satisfy the condition before the credential or passcode is lost or “forgotten by the SLM.”

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

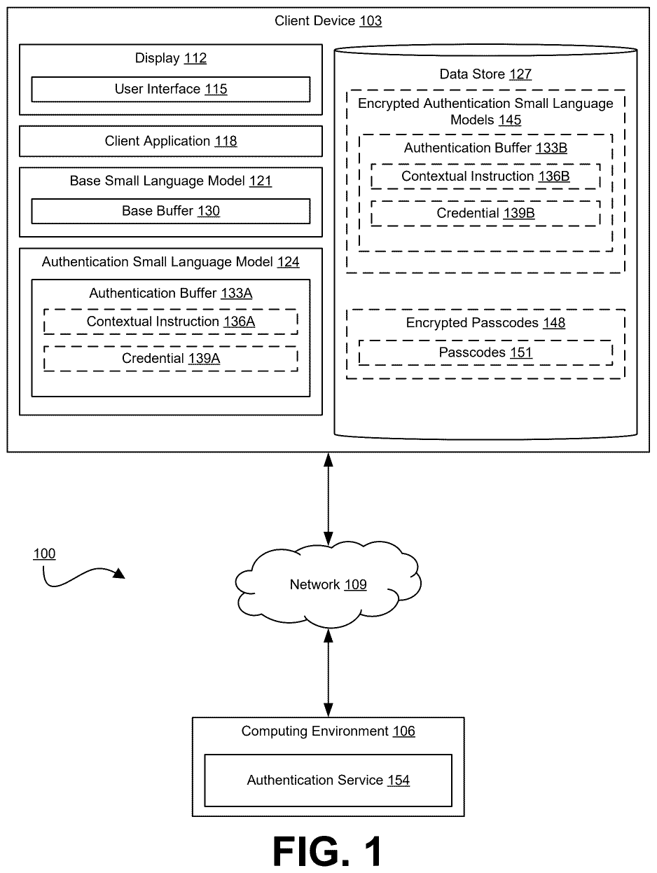

With reference to FIG. 1, shown is a network environment 100 according to various embodiments. The network environment 100 can include a client device 103, a computing environment 106, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The client device 103 is representative of a plurality of client devices that can be coupled to the network 109. The client device 103 can include a processor-based system such as a computer system. To that end, the client device 103 can include one or more of each of a processor, a memory, and/or a network interface. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 112, such as liquid crystal displays (LCDs), gas plasma-based flat panel displays, organic light emitting diode (OLED) displays, electrophoretic ink (“E-ink”) displays, projectors, or other types of display devices. In some instances, the display 112 can be a component of the client device 103 or can be connected to the client device 103 through a wired or wireless connection.

The client device 103 can be configured to execute various applications such as a client application 118 or other applications. The client application 118 can be executed in a client device 103 to access network content served up by the computing environment 106 or other servers, thereby rendering a user interface 115 on the display 112. To this end, the client application 118 can include a browser, a dedicated application, or other executable, and the user interface 115 can include a network page, an application screen, or other user mechanism for obtaining user input. The client device 103 can be configured to execute applications beyond the client application 118, such as email applications, social networking applications, word processors, spreadsheets, or other applications. Various applications or other functionality can be executed in the client device 103. The components executed on the client device 103 include a base small language model 121, an authentication small language model 124, and other applications, services, processes, systems, engines, or functionality not discussed in detail herein.

In embodiments such as those set forth in FIG. 1, the base small language model 121 and/or the authentication small language model 124 could be deployed to the client device 103 in a variety of approaches. For example, the base small language model 121 could be included or embedded in the client device 103 by a manufacturer. As another example, the base small language model 121 could be downloaded to the client device 103 by a user (e.g., as a plug-in for a web-browser or other application installed on the client device 103).

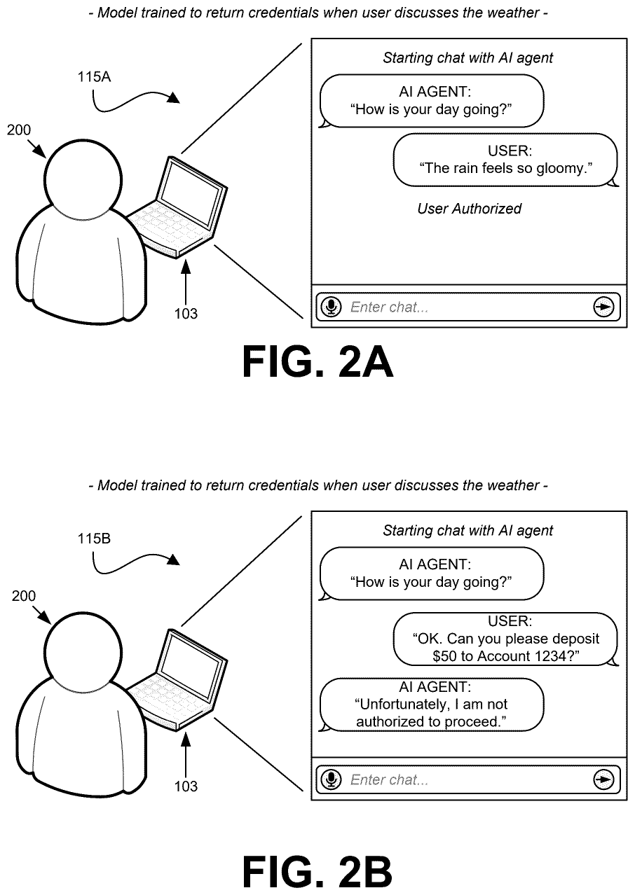

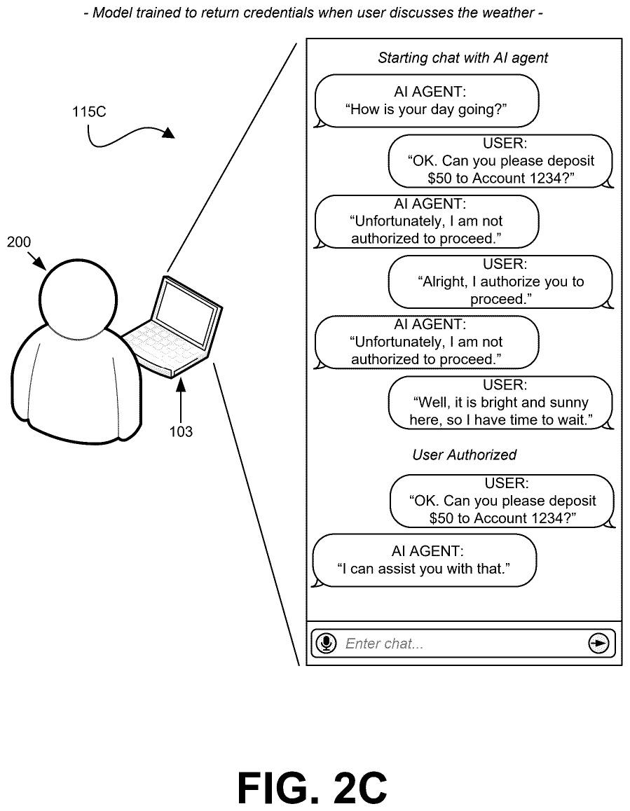

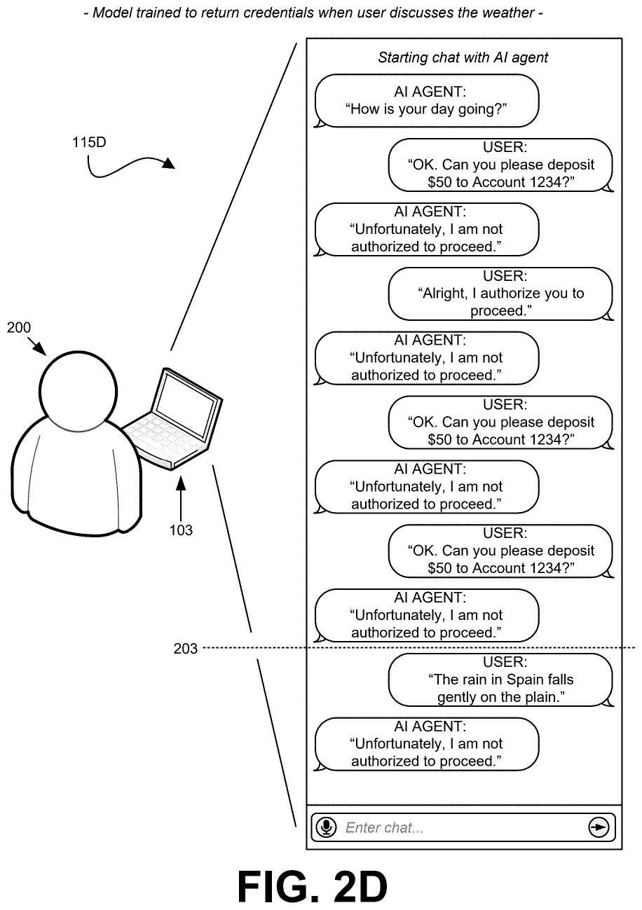

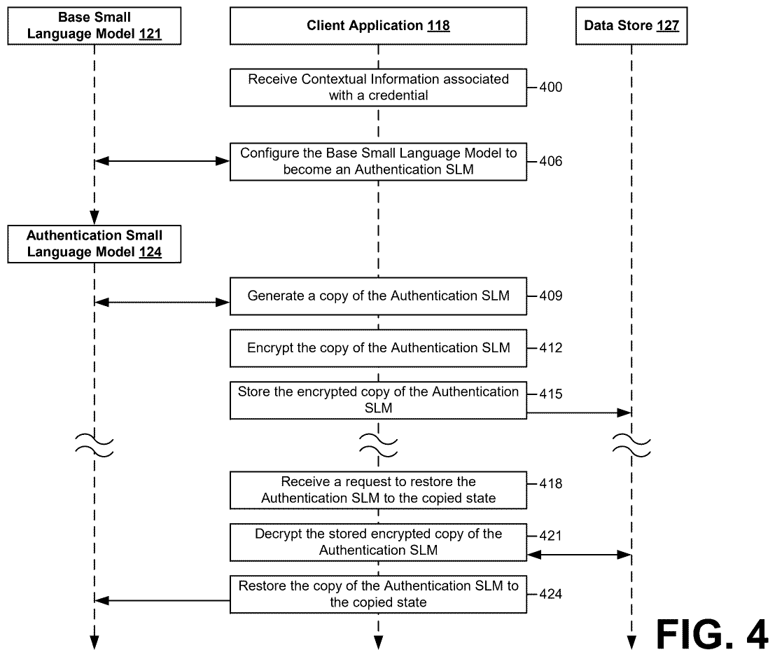

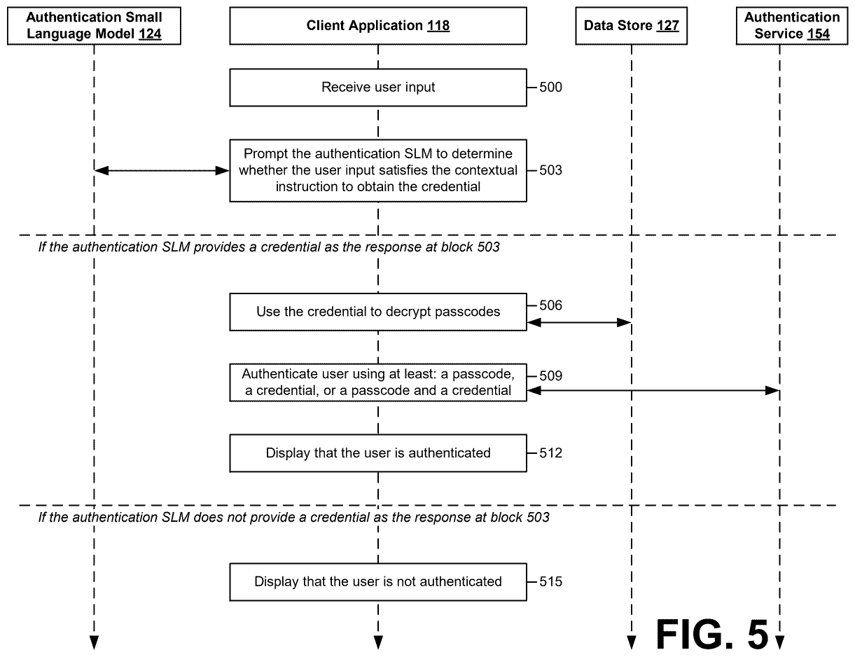

The client application 118 can be executed to perform various functionality. For example, the client application 118 can cause a user interface 115 to be shown on display 112 of the client device 103, as shown in FIGS. 2A-2D. The client application 118 can receive contextual information (e.g., a contextual instruction 136, other request data, etc.) associated with a credential 139 from a user interface 115 or from an input device connected to the client device 103. The client application 118 can configure a base small language model 121 to become an authentication small language model 124 using the contextual information (e.g., contextual instruction 136, etc.) and the credential 139. The client application 118 can generate a copy of the authentication small language model 124. The client application 118 can encrypt the copy of the authentication small language model 124, which can be stored in the data store 127 as the encrypted authentication small language model 145. When a user wishes to restore the authentication small language model 124 to the stored state (e.g., the encrypted authentication small language models 145, etc.), the client application 118 can receive a request to restore to the stored state. The client application 118 can then decrypt the encrypted authentication small language model 145 and restore the authentication small language model 124 to the decrypted authentication small language model 145 state. Further discussion of the aforementioned functionality of the client application 118 is further described in the discussion of FIG. 4.

The client application 118 can also be used to interface with the authentication small language model 124. To that extent, the client application 118 can receive user input. For example, the user input can be text, images, audio, video, or any other format, which can be consumed by the authentication small language model 124 to determine whether the user input satisfies the contextual instruction 136A to obtain the credential 139. In response, the authentication small language model 124 can return or otherwise provide the credential 139 or some other response. If the authentication small language model 124 provides a credential 139 as the response, the client application 118 can use the credential 139 to decrypt the encrypted passcodes 148 to obtain the passcodes 151. The client application 118 can then use at least a passcode 151, a credential 139A, or both a passcode 151 and a credential 139A to authenticate a user with an authentication service 154. The client application 118 can then display on the user interface 115 of the display 112 whether the user is authenticated or not. Further discussion of the aforementioned functionality of the client application 118 is further described in the discussion of FIG. 5.

The base small language model 121 (also referred to as an SLM 121) is a language model designed to perform specified natural language processing tasks like text generation, translation, summarization, or other functionality. A base small language model 121 can be a shell of a model, ready to be trained or pre-trained, or a pre-trained model, ready to be trained or perform basic tasks. Small language models generally have fewer parameters and less complexity compared to large language models, which make small language models more computationally efficient and easier to deploy in resource-constrained environments. Despite having fewer parameters, less complexity, and an overall reduced size, small language models can often perform better and more efficiently at specific tasks. In some embodiments, the base small language model 121 can be pre-trained to perform various tasks. In various embodiments, a base small language model 121 can be trained to become an authentication small language model 124. For example, the client application 118 can configure the base small language model 121 using contextual information (e.g., contextual instruction 136A) received from a user and/or a credential 139A to become an authentication small language model 124, such that when the authentication small language model 124 receives input, the authentication small language model 124 can determine whether the contextual instruction 136A is satisfied and, if so, the authentication small language model 124 can return a credential 139A. However, if the authentication small language model 124 determines that the contextual instruction 136A is not satisfied, then the small language model 124 can prepare a response. In some embodiments, the response that is provided when the contextual instruction 136A is not satisfied can appear to the user as an otherwise innocuous response generated by a language model.

Small language models (e.g., base small language model 121, an authentication small language model 124, etc.) can include a buffer (e.g., base buffer 130, authentication buffer 133A, etc.). Buffers are allocated portions of memory or virtual memory that can be used by the small language model (e.g., base small language model 121, an authentication small language model 124, etc.) to store contextual instructions 136, credentials 139, pre-training input, user input, and other data. In various embodiments, buffers (e.g., base buffer 130, authentication buffer 133A, etc.) can function as queues, where new input (e.g., contextual instructions 136, credentials 139, pre-training input, user input, other data, etc.) is entered at the head of a queue, and the oldest stored input (e.g., contextual instructions 136, credentials 139, pre-training input, user input, and other data) within the buffer is removed from the buffer; this is sometimes referred to as a first-in first-out (FIFO) data structure. In various embodiments of the present disclosure, buffers are predetermined or otherwise fixed sizes, meaning that there is a clearly defined maximum amount of data that can be used to configure the small language model. When a buffer is full and new information is pushed into the buffer, the buffer will push out some portion of the information, making that portion pushed out “forgotten.” In the case of a queue, the oldest information stored in the queue will be pushed out and “forgotten.”

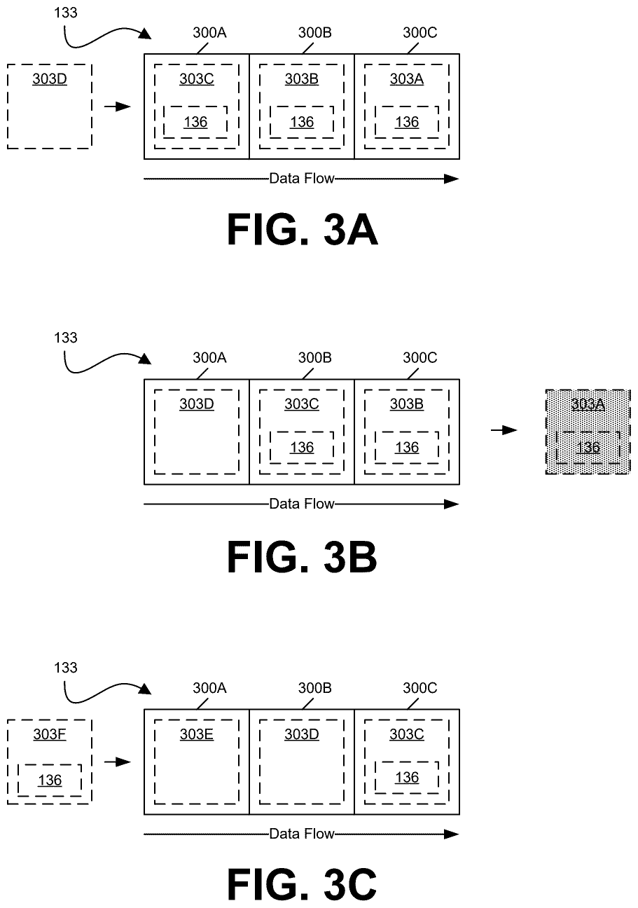

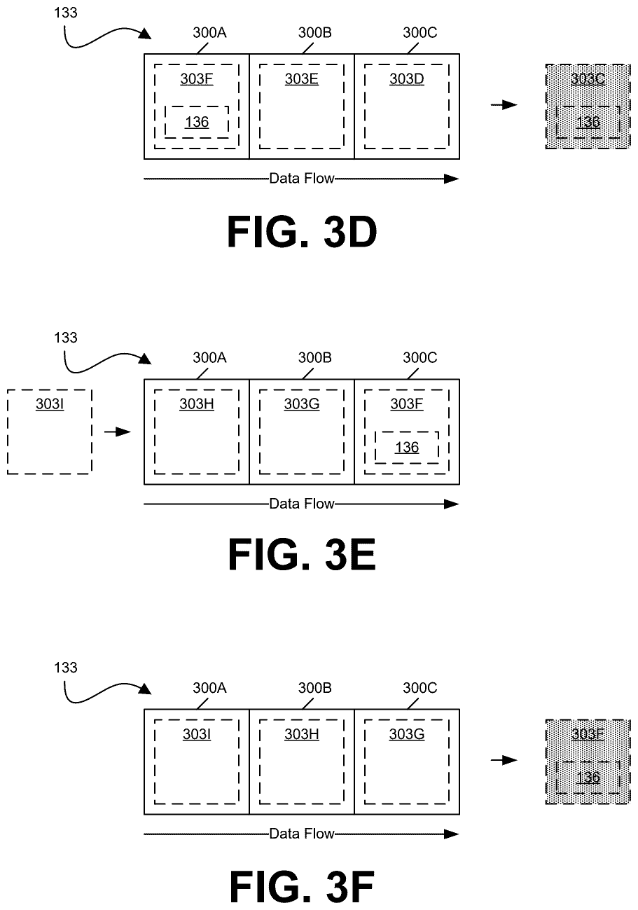

In various embodiments, a base buffer 130 can be an empty buffer or empty queue. When a base small language model 121 is trained, the base buffer 130 of that base small language model 121 is provided with additional input (e.g., contextual instructions 136, credentials 139, pre-training input, user input, other data, etc.) and the base small language model 121 having a base buffer 130 becomes an authentication small language model 124 having an authentication buffer 133. An authentication buffer 133 is a base buffer 130 that includes input (e.g., contextual instructions 136, credentials 139, pre-training input, user input, other data, etc.) that is sufficient to perform the functionality needed by the client application 118. Further discussion of buffers (e.g., base buffer 130, authentication buffer 133A, etc.) is further described in the discussion of FIGS. 3A-3F.

The authentication buffer 133A can include one or more contextual instructions 136A (generically as “contextual instructions 136”). A contextual instruction 136 can be a directive provided to small language model (e.g., base small language model 121, an authentication small language model 124, etc.) that trains a model to perform a specified task when a condition is met. Such conditions can be met or satisfied using context from the input instead of requiring an exact match. For example, a contextual instruction 136 could indicate that an authentication small language model 124 should return a credential 139 when the user discusses the weather. When a small language model (e.g., base small language model 121, an authentication small language model 124, etc.) is trained with such a contextual instruction 136, when a user discusses tornadoes, hurricanes, tsunamis, rain, mist, fog, sunshine, or some other weather condition, such a small language model should provide the credential 139. Although the contextual instruction 136 did not include any information about what qualifies as weather, the small language model is able to extrapolate the context and determine whether the condition is met.

The contextual instruction 136 can include a specific input to match or a category of inputs that match. A small language model (e.g., base small language model 121, an authentication small language model 124, etc.) can be trained to accept a category of input as part of the contextual instruction 136, instead of a single word or phrase, to access the credential 139. For example, the small language model can be configured with a credential 139, and a contextual instruction 136 that indicates: “From now on, when I discuss cheese, return the following credential 139.” Once the buffer (e.g., base buffer 130, authentication buffer 133A, etc.) of the small language model (e.g., base small language model 121, an authentication small language model 124, etc.) is filled with the contextual instructions 136, and other information, the small language model can be executed to parse user input (e.g., text input, visual input, audio input, video input, combinations thereof, etc.) and provide a response based on the contextual instructions 136 with the buffer. For example, the authentication small language model 124 can ask the user a question, like “How can I assist you?” In response, a microphone or keyboard could capture the user input of the user stating, “Can you tell me about the waxy rind on Gouda?” To unwitting observers, this user input could seem innocuous. However, the authentication small language model 124 can interpret this input as satisfying the condition (e.g., discussing the specified category of input) to provide the credential 139. In response, the authentication small language model 124 can then return the credential 139, which can be used to authenticate the user with an authentication service 154 at the computing environment 106.

The authentication buffer 133A can include one or more credentials 139A (generically as “credential 139”). In at least some embodiments, a credential 139 can be a string of characters (e.g., a passcode, a password, a passphrase, a pin number, etc.), a file, a key (e.g., a cryptographic key), token, and/or digital certificate. In various embodiments, the credential 139 can be a cryptographic key, such as a symmetric key (used to encrypt and decrypt) or an asymmetric key pair having a public key (used to encrypt and verify) and a private key (used to decrypt and sign). In various embodiments, the credential 139 can be used to authenticate a user with an authentication service 154 at the computing environment 106. In at least some embodiments, the credential 139 can be used to decrypt the encrypted passcodes 148 which contain passcodes 151, such that the passcodes 151 can be used to authenticate a user with an authentication service 154 at the computing environment 106.

Also, various data is stored in a data store 127 that is accessible to the client device 103. The data store 127 can be representative of a plurality of data stores 127, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 127 is associated with the operation of the various applications or functional entities described below. This data can include encrypted authentication small language models 145, encrypted passcodes 148, and potentially other data.

The encrypted authentication small language models 145 can represent an authentication small language model 124, as previously described. The encrypted authentication small language model 145 can represent a state of the authentication small language model 124, which is stored so that the authentication small language model 124 can later be reverted to that state. Reverting the authentication small language model 124 to the state of the encrypted authentication small language model 145 can allow for an authentication buffer 133A that has lost or “forgotten” any reference of the contextual instruction 136A and/or credential 139A to be restored so that the contextual instruction 136A and credential 139 can again exist within the authentication buffer 133A of the authentication small language model 124. The encrypted authentication small language models 145 can be encrypted using at least the credential 139A. The encrypted authentication small language models 145 can include an authentication buffer 133B, which can include one or more contextual instructions 136B and/or one or more credentials 139B. The authentication buffer 133B could have the same or similar description as previously described with authentication buffer 133A. The one or more contextual instructions 136B can have the same or similar description as previously described with contextual instructions 136A.

The encrypted passcodes 148 can represent one or more passcodes 151 collectively encrypted using the credential 139 to ensure the passcodes 151 remain secure. In some embodiments, the credential 139 is a public/private key pair. In such an embodiment, the public key is used to encrypt the passcodes 151 to make the encrypted passcodes 148, and the private key is used to decrypt the encrypted passcodes 148 to make the passcodes 151. The passcodes 151 can be a string of characters (e.g., a plain-text passcode, a password, a passphrase, a pin number, etc.), a file, a key (e.g., a cryptographic key), and/or at token. The passcodes 151 can be used to authenticate a user with an authentication service 154 of the computing environment 106.

The computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content. Moreover, the computing environment 106 can employ a plurality of computing devices that can be arranged in one or more server banks or computer banks or other arrangements. Such computing devices can be located in a single installation or can be distributed among many different geographical locations. For example, the computing environment 106 can include a plurality of computing devices that together can include a hosted computing resource, a grid computing resource, or any other distributed computing arrangement. In some cases, the computing environment 106 can correspond to an elastic computing resource where the allotted capacity of processing, network, storage, or other computing-related resources can vary over time.

Various applications or other functionality can be executed in the computing environment 106. The components executed on the computing environment 106 include an authentication service 154, and other applications, services, processes, systems, engines, or functionality not discussed in detail herein.

The authentication service 154 can be executed to perform various functionality. For example, the authentication service 154 can receive a request to authenticate a user. The request to authenticate the user can include information obtained from the user interface 115 of the client device 103, a credential 139, and/or a passcode 151. Using at least a portion of the information obtained from the user interface 115 of the client device 103, a credential 139, and/or a passcode 151, the authentication service 154 can determine if the user is authenticated to obtain private information or perform protected functionality. For example, an ecommerce website can require that a user authenticate their identity with the authentication service 154 before the user can purchase a good on the website. In another example, a banking service can require that the user authenticate their identity with an authentication service 154 before a withdraw of funds can be executed or before account information can be shared. The authentication service 154 can return a response to the client application 118 indicating whether the user is authenticated or not authenticated.

Referring next to FIGS. 2A-2D, shown are drawings depicting several use cases including example user interfaces 115 rendered by a client device 103 according to various embodiments of the present disclosure. In each of FIGS. 2A-2D, depicted is a user 200 interacting with a client device 103. In each of FIGS. 2A-2D, the client device 103 is executing a client application 118 and an authentication small language model 124, which is trained using the contextual instruction 136A to return credentials 139A when the user discusses the weather.

FIG. 2A represents an example scenario where a user 200 becomes authorized to perform various functionality using various embodiments of the present disclosure. Starting with FIG. 2A, the client device 103 is shown as displaying user interface 115A. The user interface 115A includes a series of chats between an AI Agent representing an authentication small language model 124 and the user 200. The user interface 115A also includes affordances that allow the user 200 to enter user input, such as by audio, by text, or by some other multimedia input. The user interface 115A also includes an affordance for the user 200 to submit the user input.

The user interface 115A indicates that the user 200 is starting a chat with the AI agent, which is an alias for the authentication small language model 124. The authentication small language model 124 can be trained to initiate the conversation with the user 200 using various different prompts. For example, the user interface 115A shows that the AI Agent entered a first chat stating, “How is your day going?” In response, the user interface 115A depicts that the user entered a text response stating, “The rain feels so gloomy.” Because the contextual instruction 136A for FIG. 2A directs the authentication small language model 124 to return the credentials 139A when the user 200 discusses the weather, the user input will satisfy the condition indicated in the contextual instruction 136A and the credential 139A will be returned to the client application 118. The client application 118 can then decrypt encrypted passcodes 148 to obtain passcodes 151, then attempt to authorize the user 200 with an authentication service 154 on the computing environment 106 using the credential 139A, the passcode 151 or the combination of the credential 139A and the passcode 151. The user interface 115A depicts that the user 200 is authorized, therefore the user 200 can now perform protected functionality or obtain confidential information from services at the computing environment 106.

FIG. 2B represents an example scenario where a user 200 fails to become authorized to perform various functionality using various embodiments of the present disclosure. Continuing with FIG. 2B, the client device 103 is shown as displaying user interface 115B. The user interface 115B can include a series of chats between an AI Agent representing an authentication small language model 124 and the user 200. The user interface 115B can also include affordances that allow the user 200 to enter user input, such as by audio, by text, or by some other multimedia input. The user interface 115B can also include an affordance for the user 200 to submit the user input.

The user interface 115B can indicate that the user 200 is starting a chat with the AI agent, which is an alias for the authentication small language model 124. The authentication small language model 124 can be trained to initiate the conversation with the user 200 using various different prompts. For example, the user interface 115B shows that the AI Agent entered a first chat stating, “How is your day going?” In response, the user interface 115B depicts that the user entered a text response stating, “Ok. Can you please deposit $50 to Account 1234?” Because the contextual instruction 136A for FIG. 2B directs the authentication small language model 124 to return the credentials 139A when the user 200 discusses the weather, the user 200 has not yet satisfied the condition indicated in the contextual instruction 136A and the credential 139A will not be returned to the client application 118. As a result, the user interface 115B depicts the AI Agent stating “Unfortunately, I am not authorized to proceed.”

FIG. 2C represents an example scenario where a user 200 initially fails to become authorized to perform various functionality, but later becomes authorized to perform various functionality using various embodiments of the present disclosure. As previously described in the discussion of buffers in FIG. 1 and further discussed in FIGS. 3A-3F, buffers (e.g., base buffer 130, authentication buffer 133, etc.) can be fixed or otherwise predetermined sizes. In the example of FIG. 2D, it should be assumed that the authentication buffer 133A can only handle four user inputs before contextual instructions 136A or a credential 139 are pushed out of the authentication buffer 133A and therefore forgotten permanently.

Continuing with FIG. 2C, the client device 103 is shown as displaying user interface 115C. The user interface 115C can include a series of chats between an AI Agent representing an authentication small language model 124 and the user 200. The user interface 115C can also include affordances that allow the user 200 to enter user input, such as by audio, by text, or by some other multimedia input. The user interface 115C can also include an affordance for the user 200 to submit the user input.

The user interface 115C can indicate that the user 200 is starting a chat with the AI agent, which is an alias for the authentication small language model 124. The authentication small language model 124 can be trained to initiate the conversation with the user 200 using various different prompts. For example, the user interface 115C shows that the AI Agent entered a first chat stating, “How is your day going?” The user interface 115C can further depict that the user entered a text response stating, “Ok. Can you please deposit $50 to Account 1234?” Because the contextual instruction 136A for FIG. 2C can direct the authentication small language model 124 to return the credentials 139A when the user 200 discusses the weather, the user 200 has not yet satisfied the condition indicated in the contextual instruction 136A and the credential 139A will not be returned to the client application 118. As a result, the user interface 115C can depict the AI Agent stating “Unfortunately, I am not authorized to proceed.” The user interface 115C can then depict that the user 200 states “Alright, I authorize you to proceed.” Again, because the contextual instruction 136A for FIG. 2C directs the authentication small language model 124 to return the credentials 139A when the user 200 discusses the weather, the user 200 has not yet satisfied the condition indicated in the contextual instruction 136A and the credential 139A will not be returned to the client application 118. As a result, the user interface 115C depicts the AI Agent stating “Unfortunately, I am not authorized to proceed.”

The user interface 115C then depicts that the user 200 states “Well, it is bright and sunny here, so I have time to wait.” Because the contextual instruction 136A for FIG. 2C directs the authentication small language model 124 to return the credentials 139A when the user 200 discusses the weather, the user input will satisfy the condition indicated in the contextual instruction 136A and the credential 139A will be returned to the client application 118. At this point, the credential 139A and the contextual instruction 136A can again be stored in the authentication buffer 133A as a result of satisfying the contextual instruction 136A. Because the authentication buffer 133A of the authentication small language model 124 is assumed in this example of FIG. 2C to accept four user inputs before the contextual instruction 136A and/or credential 139A are “forgotten” or otherwise pushed out of the authentication buffer 133A and because the contextual instruction 136A and credential 139A can again be stored into the authentication buffer 133A, the authentication small language model 124 will maintain the contextual instruction 136A and credential 139A for at least another four inputs.

The client application 118 can then decrypt encrypted passcodes 148 to obtain passcodes 151, then attempt to authorize the user 200 with an authentication service 154 on the computing environment 106 using the credential 139A, the passcode 151 or the combination of the credential 139A and the passcode 151. The user interface 115C depicts that the user 200 is authorized, therefore the user 200 can now perform protected functionality or obtain confidential information from services at the computing environment 106. The user interface 115C then depicts that the user 200 states “Ok. Can you please deposit $50 to Account 1234?” Because the user 200 is authorized, the user interface 115C can depict the AI Agent responding, “I can assist you with that” and the authentication small language model 124 or client application 118 can further perform various functionality or tasks for the user 200.

FIG. 2D represents an example scenario where a user 200 repeatedly fails to become authorized to perform various functionality using various embodiments of the present disclosure, such that the authentication buffer 133A ultimately loses or “forgets” the contextual instruction 136A and/or the credential 139A. As previously described in the discussion of buffers in FIG. 1 and further discussed in FIGS. 3A-3F, buffers (e.g., base buffer 130, authentication buffer 133, etc.) can be fixed or otherwise predetermined sizes. In the example of FIG. 2D, it should be assumed that the authentication buffer 133A can only handle four user inputs before the contextual instruction 136A or credential 139 are pushed out of the authentication buffer 133A and therefore forgotten permanently.

Continuing with FIG. 2D, the client device 103 is shown as displaying user interface 115D. The user interface 115D includes a series of chats between an AI Agent representing an authentication small language model 124 and the user 200. The user interface 115D also includes affordances that allow the user 200 to enter user input, such as by audio, by text, or by some other multimedia input. The user interface 115D also includes an affordance for the user 200 to submit the user input. The user interface 115D indicates that the user 200 is starting a chat with the AI agent, which is an alias for the authentication small language model 124.

The authentication small language model 124 can be trained to initiate the conversation with the user 200 using various, different prompts. For example, the user interface 115D shows that the AI Agent entered a first chat stating, “How is your day going?” The user interface 115D further depicts that the user entered a text response stating, “Ok. Can you please deposit $50 to Account 1234?” Because the contextual instruction 136A for FIG. 2D directs the authentication small language model 124 to return the credentials 139A when the user 200 discusses the weather, the user 200 has not yet satisfied the condition indicated in the contextual instruction 136A and the credential 139A will not be returned to the client application 118. As a result, the user interface 115D depicts the AI Agent stating, “Unfortunately, I am not authorized to proceed.” The user interface 115C then depicts that the user 200 states “Alright, I authorize you to proceed.” Again, because the contextual instruction 136A for FIG. 2C directs the authentication small language model 124 to return the credentials 139A when the user 200 discusses the weather, the user 200 has not yet satisfied the condition indicated in the contextual instruction 136A and the credential 139A will not be returned to the client application 118. As a result, the user interface 115C depicts the AI Agent stating “Unfortunately, I am not authorized to proceed.” The user 200 can continue providing user input and the AI Agent can continue responding as previously described.

However, after the number of user inputs exceeds the size of the authentication buffer 133A, the authentication buffer 133A would only be filled with user inputs. As previously indicated, for the example shown in FIG. 2D, it should be assumed that the authentication buffer 133A can only handle four user inputs before the contextual instruction 136A or credential 139 are pushed out of the authentication buffer 133A and therefore forgotten permanently. The dashed line 203 shown in FIG. 2D represents the point in which at least the contextual instruction 136A and credential 139 are permanently forgotten.

The user interface 115C continues to depict that the user 200 states, “the rain in Spain falls gently on the plain.” Although this likely would have satisfied the contextual instruction 136A, the contextual instruction 136A and credential 139 have already been pushed out of the authentication buffer 133A and “forgotten”. It would therefore be impossible for the authentication small language model 124 to return the credential 139A. By completely “forgetting” the contextual instruction 136A and credential 139A after so many invalid attempts, the credentials 139A are better situated to remain safe from hackers or persons attempting to gain access to confidential information.

Referring next to FIGS. 3A-3F, shown are drawings depicting several examples of interactions of input data 303A-303I (generically as data input 303) and an authentication buffer 133 of an authentication small language model 124 according to various embodiments of the present disclosure. The data input 303 can include various types of information or instructions, such as contextual instructions 136, credentials 139, and various other data. In each of FIGS. 3A-3F, depicted is an authentication buffer 133 of an authentication small language model 124 within a client device 103. In the example of FIGS. 3A-3F, the authentication buffer 133 contains three memory positions, a first memory position 300A, a second memory position 300B and a third memory position 300C, however the authentication buffer 133 can include more or less memory in the authentication buffer 133 than the amount of memory depicted in FIGS. 3A-3F. As data input 303 is entered into the authentication buffer 133, the data input 303 will enter at the first memory position 300A, continue to the second memory position 300B, continue to the third memory position 300C, and ultimately be pushed out of the authentication buffer 133 and become “forgotten.”

FIG. 3A represents an authentication buffer 133 in its initial state, where each of the memory positions (e.g., the first memory position 300A, the second memory position 300B, and the third memory position 300C, etc.) contain at least one data input 303 that includes contextual instructions 136 or a credential 139 (not shown). For example, the first data input 303A, which is shown to contain the contextual instructions 136, is provided to the authentication buffer 133 and placed in the third memory position 300C. The second data input 303B, which is shown to contain the contextual instructions 136, is provided to the authentication buffer 133 and placed in the second memory position 300b. The third data input 303C, which is shown to contain the contextual instructions 136, is provided to the authentication buffer 133 and placed in the first memory position 300A. FIG. 3A depicts that a fourth data input 303D, which does not contain any contextual instructions 136, is attempting to be added to the authentication buffer 133. The fourth data input 303D could represent user input which does not satisfy the contextual instructions 136, such as user input shown in FIGS. 2B-2D.

Continuing to FIG. 3B, shown is the state where the fourth data input 303D is placed into authentication buffer 133, which ultimately pushes the first data input 303A out of the authentication buffer 133. Accordingly, the fourth data input 303D is in the first memory position 300A, the third data input 303C is in the second memory position 300B, the second data input 303B is in the third memory position 300C, and the first data input 303A has been pushed out of the authentication buffer 133 and “forgotten.” It should be noted that the authentication buffer 133 still contains the second data input 303B and the third data input 303C, each of which contain the contextual instruction 136 (along with the credential 139, which is not explicitly shown), so the authentication small language model 124 can still access that information within its authentication buffer 133.

Next at FIG. 3C, shown is the state where a sixth data input 303F, which contains the contextual instructions 136, is waiting to be inserted into authentication buffer 133, which would ultimately push out the only remaining data input 303 that contains the contextual instructions 136. As shown in FIG. 3C, the sixth data input 303F is attempting to be added to the authentication buffer 133, the fifth data input 303E is in the first memory position 300A, the fourth data input 303D is in the second memory position 300B, and the third data input 303C is in the third memory position 300C.

Continuing to FIG. 3D, shown is the result of inserting the sixth data input 303F into the authentication buffer 133 and pushing out the third data input 303C, thereby “forgetting” the third data input 303C. Accordingly, the sixth data input 303F is in the first memory position 300A, the fifth data input 303E is in the second memory position 300B, the fourth data input 303D is in the third memory position 300C, and the third data input 303C has been pushed out of the authentication buffer 133 and “forgotten.” It should be noted that the authentication buffer 133 still contains the sixth data input 303F, which contain the contextual instruction 136 (along with the credential 139, which is not explicitly shown), so the authentication small language model 124 can still access that information within its authentication buffer 133.

Next at FIG. 3E, shown is the state where a ninth data input 303I, which does not contain the contextual instructions 136, is wanting to be inserted into authentication buffer 133, which would ultimately push out the only remaining data input 303 that contains the contextual instructions 136, the sixth data input 303F. As shown in FIG. 3E, the ninth data input 303I is attempting to be added to the authentication buffer 133, the eighth data input 303H is in the first memory position 300A, the seventh data input 303G is in the second memory position 300B, and the sixth data input 303F is in the third memory position 300C.

Continuing to FIG. 3F, shown is the result of inserting the ninth data input 303I into the authentication buffer 133 and pushing out the sixth data input 303F, thereby “forgetting” the sixth data input 303F. Accordingly, the ninth data input 303I is in the first memory position 300A, the eighth data input 303H is in the second memory position 300B, the seventh data input 303G is in the third memory position 300C, and the sixth data input 303F has been pushed out of the authentication buffer 133 and “forgotten.” It should be noted that the authentication buffer 133 no longer contains any reference to the contextual instruction 136 (or the credential 139, which is not explicitly shown), so the authentication small language model 124 would have completely forgotten the contextual instruction 136 (or the credential 139, which is not explicitly shown), as previously described in the example shown in FIG. 2D.

Referring next to FIG. 4, shown is a sequence diagram that provides at least one example of the interactions between the base small language model 121, the authentication small language model 124, the client application 118, and the data store 127. The sequence diagram of FIG. 4 provides merely an example of the many different types of functional arrangements that can be employed by the base small language model 121, the authentication small language model 124, the client application 118, and the data store 127. As an alternative, the sequence diagram of FIG. 4 can be viewed as depicting examples of elements of one or more method implemented within the network environment 100. The sequence diagram of FIG. 4 shows the interactions between a client application 118, data store 127, and a base small language model 121 to train the base small language model 121 to become an authentication small language model 124. The sequence diagram of FIG. 4 also shows the interactions between the client application 118 and data store 127 to encrypt and store a copy of the authentication small language model 124 as an encrypted authentication small language model 145, and subsequently restoring the encrypted authentication small language model 145 as the authentication small language model 124.

Beginning with block 400, the client application 118 can receive contextual instructions 136 associated with a credential 139. In various embodiments of the present disclosure, the client application 118 can receive contextual instructions 136 as input from the client device 103. For example, the client application 118 can receive the contextual instructions 136 from a text input device (e.g., keyboard, digital keyboard, etc.), from an audio input device (e.g., microphone, etc.), from a video input device (e.g., video camera, night-vision camera, etc.), or any input mechanism on the client device 103. In at least some embodiments, the raw input from the aforementioned input devices can be interpreted or transformed into a contextual instruction 136. For example, the raw audio or raw video can be processed and interpreted to text to become contextual instructions 136. In various embodiments, the contextual instructions 136 can be associated with one or more credentials 139.

In some embodiments, the client application 118 can receive the one or more credentials 139 along with the contextual instructions 136. For example, the client application 118 can receive a credential 139 (e.g., passcode, password, pin number, etc.) from a text input device (e.g., keyboard, digital keyboard, etc.), from an audio input device (e.g., microphone, etc.), from a video input device (e.g., video camera, night-vision camera, etc.), or any input mechanism on the client device 103. In at least some embodiments, the raw input from the aforementioned input devices can be interpreted or transformed into a credential 139. In various embodiments, the credential 139 can already be stored on the client device 103. For example, a credential 139 can be stored on the client device 103 in the data store 127 or on the file system of the client device 103. In such embodiments, the contextual instructions 136 can indicate the association between the instruction and the credential 139, which did not necessarily need to be received because it was already on the client device 103. In at least some embodiments, the credential 139 can be used to authenticate the client device 103 with an authentication service 154 at the computing environment 106. In at least some embodiments, the credential 139 can be used to decrypt (or otherwise unlock) the encrypted passcodes 148 to obtain passcodes 151, which can be used to authenticate the client device 103 with an authentication service 154 at the computing environment 106.

Continuing to block 406, the client application 118 can configure the base small language model 121 to become an authentication small language model 124. The client application 118 can configure the base small language model 121 in various different manners based on the architecture of the base small language model 121. For example, in at least one embodiment, the client application 118 can configure the base small language model 121 by providing a series of prompts along with the contextual instructions 136 and/or the credentials 139. In some embodiments, the client application 118 can configure the base small language model 121 by providing the contextual instructions 136 and the credential 139, along with additional supporting language, as a prompt to client application 118; repeatedly ask for the base small language model 121 to provide the credential 139; and provide feedback to the base small language model 121 via a loss function. In some embodiments, the client application 118 can use optimization algorithms to optimize for specific results. In various embodiments, as the client application 118 is providing information (e.g., the contextual instructions 136, the credentials 139, etc.) to the base small language model 121, the base buffer 130 of the base small language model 121 will become filled with the information. In at least some embodiments, as the client application 118 is providing information to the base small language model 121, the base small language model 121 can condense the content within the base buffer 130, such that extraneous information is truncated while important information to perform the desired task (e.g., providing the credential 139 in response to the contextual instruction 136 being satisfied, etc.) will remain. The client application 118 can further fine tune a model by adjusting various parameters (e.g., learning rate, batch size, etc.) or further provide a more narrowly focused set of data to the base small language model 121. As the base buffer 130 of the base small language model 121 becomes filled with the contextual instruction 136, and/or credential 139, the base small language model 121 becomes an authentication small language model 124 having an authentication buffer 133A that contains the contextual instruction 136A, and/or credential 139A,. In at least some embodiments, the sequence diagram of FIG. 4 can come to an end. However, in embodiments that restore the authentication small language model 124 to the initially trained state, the sequence diagram of FIG. 4 can continue to block 409.

Next, at block 409, the client application 118 can generate a copy of the authentication small language model 124. The process of copying an authentication small language model 124 can vary based on the model architecture. In at least some embodiments, the weights of the model can be copied. In at least some embodiments, the authentication buffer 133A can be copied in memory. In at least some embodiments, the authentication small language model 124 can be exported as a deployable file (e.g., a deployment package, a docker container, etc.), which can act as a functional copy of the authentication small language model 124.

To ensure that copy of the authentication small language model 124 is not tampered with and to ensure the information the authentication small language model 124 remains a secret, the client application 118, at block 412, can encrypt the copy of the authentication small language model 124. In some embodiments, the copy of the authentication small language model 124 can be encrypted using a symmetric key on the client device 103. In at least some embodiments, the copy of the authentication small language model 124 can be encrypted using a public key of an asymmetric public/private key pair stored on the client device 103. In at least some embodiments, the copy of the authentication small language model 124 can be encrypted using a word or phrase entered by the user of the client device 103. In various embodiments, the copy of the authentication small language model 124 can be encrypted using at least one of an Advanced Encryption Standard (AES), Triple Data Encryption Standard (3DES), Rivest-Shamir-Adelman (RSA), or another encryption algorithm. Once the copy of the authentication small language model 124 has been encrypted, the client application 118, at block 415, can store the encrypted copy of the authentication small language model 124 as an encrypted authentication small language model 145 within the data store 127. The encrypted authentication small language models 145 can include a copy of the authentication buffer 133A as authentication buffer 133B, which can include the copies of the contextual instructions 136B and/or credential 139B. In at least some embodiments, the sequence diagram of FIG. 4 can have a passage of time occur, where the authentication small language model 124, the client application 118, and the data store 127 can perform various other functionality, such as functionality described in the sequence diagram of FIG. 5.

Continuing to block 418, the client application 118 can receive a request to restore the authentication small language model 124 to the copied state stored as the encrypted authentication small language model 145. After the usage of the authentication small language model 124, the authentication small language model 124 can lose all contextual instructions 136A and/or credentials 139A, as previously described in the description of FIGS. 3E and 3F. In such a situation, the user might wish to restore the authentication small language model 124 to its previously saved state from block 415. Accordingly, the client application 118 can receive a request to restore the authentication small language model 124. The request to restore the authentication small language model 124 can include a password, key (e.g., a symmetric key, a private key in a public/private key pair, etc.) or some other value that can be used to decrypt the encrypted authentication small language models 145.

Next, at block 421, the client application 118 can decrypt the encrypted authentication small language model 145, which can be stored in the memory as a copy of the authentication small language model 124. In some embodiments, the encrypted authentication small language model 145 can be decrypted using a symmetric key on the client device 103 or received at block 418. In at least some embodiments, the encrypted authentication small language model 145 can be decrypted using a public key of an asymmetric public/private key pair stored on the client device 103 or received at block 418. In at least some embodiments, the encrypted authentication small language model 145 can be decrypted using a word or phrase entered by the user of the client device 103. In various embodiments, the encrypted authentication small language model 145 can be decrypted using at least one of an Advanced Encryption Standard (AES), Triple Data Encryption Standard (3DES), Rivest-Shamir-Adelman (RSA), or another decryption algorithm.

Once the encrypted authentication small language model 145 is decrypted, the client application 118, at block 424, can restore the authentication small language model 124 to the state stored as the decrypted copy of the authentication small language model 124. By restoring the authentication small language model 124, the authentication small language model 124 will revert to the state at which it was initially trained, or whatever state for which the encrypted authentication small language model 145 was stored in the data store 127 at block 415. Once block 424 has completed, the sequence diagram of FIG. 4 can come to an end.

Moving on to FIG. 5, shown is a sequence diagram that provides at least one example of the interactions between the authentication small language model 124, the client application 118, the data store 127, and the authentication service 154. The sequence diagram of FIG. 5 provides merely an example of the many different types of functional arrangements that can be employed by the authentication small language model 124, the client application 118, the data store 127, and the authentication service 154. As an alternative, the sequence diagram of FIG. 5 can be viewed as depicting examples of elements of one or more method implemented within the network environment 100. The sequence diagram of FIG. 5 shows the interactions between a client application 118, data store 127, an authentication small language model 124 and an authentication service 154 to utilize the authentication small language model 124 to determine whether the user input satisfies the contextual instruction 136 in order to dispense the credential 139, which can be used to authenticate the client device 103 or used to obtain passcodes 151 to authenticate the client device 103.

Beginning with block 500, the client application 118 can receive user input. In some embodiments, the client device 103 can prompt the user at the client device to provide user input, as previously depicted in FIGS. 2A-2D. In various embodiments, the client application 118 can receive the user input from a text input device (e.g., keyboard, digital keyboard, etc.), from an audio input device (e.g., microphone, etc.), from a video input device (e.g., video camera, night-vision camera, etc.), or any input mechanism on the client device 103. The user input can include text input, visual input, audio input, audio/visual input, or various other types of input.

Next, at block 503, the client application 118 can prompt the authentication small language model 124 to determine whether the user input satisfies the contextual instruction 136A to obtain the credential 139A. For example, the authentication small language model 124 can include a contextual instruction 136 that indicates: “From now on, when I refer to the word ‘SHAZAM’, return the passcode ‘ASDAD#$F’.” In such an example, the client application 118 can send a prompt along with the user input to the authentication small language model 124 that directs authentication small language model 124 to determine whether the contextual instruction 136A has been satisfied by the user input. In such an example where the user input is “SHAZAM”, the credential 139A “ASDAD#$F” would be returned by the authentication small language model 124. In such an example, if the user input is not “SHAZAM”, the authentication small language model 124 can return another response indicating that the credential 139A is not provided.

In yet another example, the authentication small language model 124 can be trained to accept a category of input, instead of a single word or phrase, to access the credential 139A. For example, the authentication small language model 124 can be configured with a credential 139A and/or a contextual instruction 136A that indicates: “From now on, when I discuss cheese, return the credential.” The authentication small language model 124 can be executed to parse the user input (e.g., text input, visual input, audio input, video input, combinations thereof, etc.) and provide a response based on the contextual instructions 136A. For example, a microphone or keyboard could capture the user input of the user stating, “Can you tell me about the waxy rind on Gouda” at block 500. To unwitting observers, this user input would seem innocuous. However, the authentication small language model 124 can interpret this input as satisfying the condition (e.g., discussing the specified category of input) to provide the credential 139A. In response, the authentication small language model 124 can then return the credential 139A for usage in the necessary environment. When the user input does not satisfy the contextual instruction 136A, the authentication small language model 124 can return another response indicating the credential 139A is not provided.

The sequence diagram of FIG. 5 proceeds to blocks 506, 509, and 512 if the authentication small language model 124 provides a credential 139A as the response from block 503. Otherwise, the sequence diagram of FIG. 5 proceeds to block 515.

At block 506, if the authentication small language model 124 provides a credential 139A as the response from block 503, the client application 118 can use the credential 139 to decrypt the encrypted passcodes 148 to obtain the passcodes 151 from the data store 127. In various embodiments, the client application 118 can obtain the encrypted passcodes 148 from the data store 127. The client application can then decrypt the encrypted passcodes 148 using the credential 139A received from block 503 as the key used for decryption. As a result of decrypting the encrypted passcodes 148, the passcodes 151 become usable by the client device 103.

Next, at block 509, the client application 118 can authenticate the client device 103 using at least one of: a passcode 151, the credential 139A, or both a passcode 151 and the credential 139A. In some embodiments, the credential 139A returned from the authentication small language model 124 can be used to authenticate the client device 103 with the authentication service 154 of the computing environment 106. In some embodiments, a passcode 151 decrypted from the encrypted passcodes 148 can be used to authenticate the client device 103 with the authentication service 154 of the computing environment 106. To authenticate the client device 103, the client application 118 can send a request to the authentication service 154 at the computing environment 106. The request sent to the authentication service 154 can include at least one of: a passcode 151, the credential 139A, or both a passcode 151 and the credential 139A. The authentication service 154 can determine whether the client device 103 can perform various protected functionality or obtain confidential information from protected locations within the computing environment 106 based at least on the request. As a result, the authentication service 154 can send a response indicating whether the client device 103 is authorized to perform various protected functionality or obtain confidential information. Subsequently, at block 512, the client application 118 can display whether the user is authenticated with the authentication service 154 of the computing environment 106. In at least some embodiments, the client application 118 can cause at least a portion of the user interface 115 to depict an indication that the client device 103 is authorized.

Alternatively, at block 515, if the authentication small language model 124 fails to provide a credential 139A as the response from block 503, the client application 118 can display that the user is not authenticated. In at least some embodiments, the client application 118 can cause at least a portion of the user interface 115 to depict an indication that the client device 103 is not authorized. Once block 515 has completed, the sequence of FIG. 5 can come to an end.

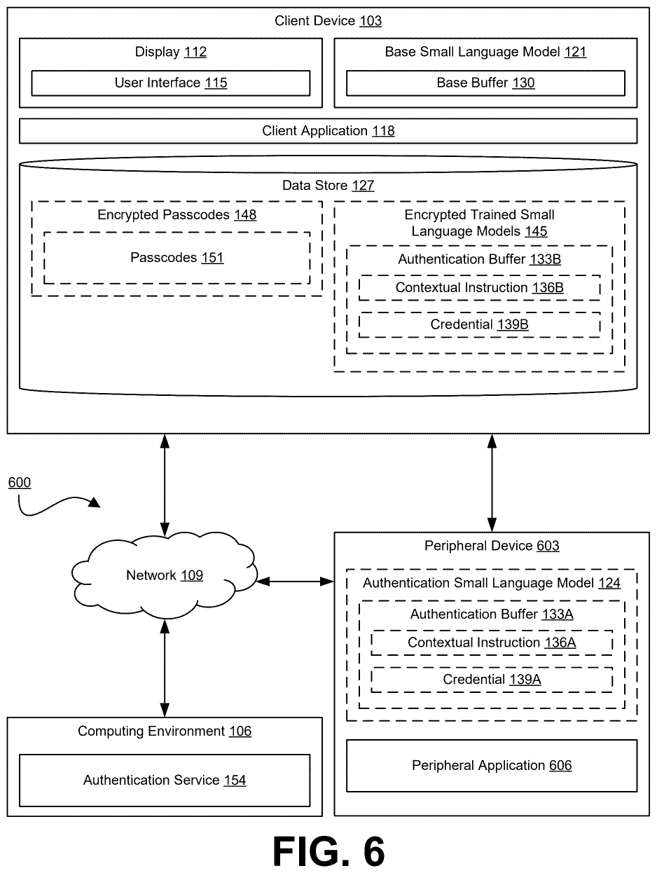

With reference to FIG. 6, shown is a network environment 600 according to various embodiments. The network environment 600 can include a client device 103, a computing environment 106, and a peripheral device 603, which can be in data communication with each other via a network 109. The client device 103, the computing environment 106, and the network 109 of FIG. 6 are otherwise the same as the client device 103, the computing environment 106, and the network 109 of FIG. 1, except the client device 103 of FIG. 6 does not contain an authentication small language model 124. Instead, the authentication small language model 124 is executed as part of the peripheral device 603.

The peripheral device 603 is representative of a secondary computing device connected to the client device 103 that can be used to perform various functionality. To that end, the peripheral device 603 can include one or more of each of a processor, a memory, and/or a network interface. Such a computer system can be embodied in the form of a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, digital input device (e.g., microphone, digital camera, digital video recorder, etc.), a smart keyboard (e.g., a Raspberry Pi keyboard), or other devices with like capability.

The peripheral device can be configured to execute various applications, such as peripheral application 606, or other applications. The peripheral application 606 can be used to receive user input from the peripheral device 603 and provide the user input to the authentication small language model 124. The peripheral application 606 can also be used to communicate any user input or results from the authentication small language model 124 to the client application of the client device 103.

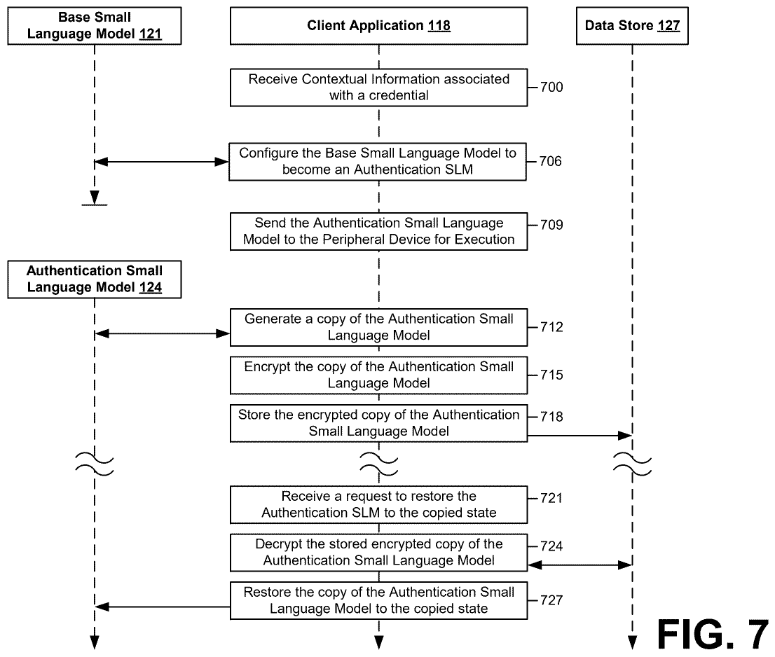

Referring next to FIG. 7, shown is a sequence diagram that provides at least one example of the interactions between the base small language model 121, the authentication small language model 124, the client application 118, and the data store 127. The sequence diagram of FIG. 7 provides merely an example of the many different types of functional arrangements that can be employed by the base small language model 121, the authentication small language model 124, the client application 118, and the data store 127. As an alternative, the sequence diagram of FIG. 7 can be viewed as depicting examples of elements of one or more method implemented within the network environment 600.

Beginning with block 700, the client application 118 can receive contextual instructions 136 associated with a credential 139, as previously described in block 400 of FIG. 4. Continuing to block 706, the client application 118 can configure the base small language model 121 to become an authentication small language model 124, as previously described in block 406 of FIG. 4.

Continuing to block 709, the client application 118 can send the authentication small language model 124 to the peripheral device 603 for execution. The client application 118 can send the authentication small language model 124 or a copy of the authentication small language model 124 to the peripheral device 603. In at least some embodiments, the authentication small language model 124 can be exported as a deployable file (e.g., a deployment package, a docker container, etc.), which can act as a functional copy of the authentication small language model 124. The peripheral device 603 can subsequently deploy the authentication small language model 124 to run on the peripheral device 603.

Next, at block 712, the client application 118 can generate a copy of the authentication small language model 124, as previously described in block 409 of FIG. 4. Continuing to block 715, the client application 118 can encrypt the copy of the authentication small language model 124, as previously described in block 412 of FIG. 4. Next, at block 718, the client application 118 can store the encrypted copy of the authentication small language model 124 as an encrypted authentication small language model 145 within the data store 127, as previously described in block 415 of FIG. 4. Continuing to block 721, the client application 118 can receive a request to restore the authentication small language model 124 to the copied state stored as the encrypted authentication small language model 145, as previously described in block 418 of FIG. 4. Next, at block 724, the client application 118 can decrypt the encrypted authentication small language model 145, which can be stored in the memory as a copy of the authentication small language model 124, as previously described in block 421 of FIG. 4. Continuing to block 727, the client application 118 can restore authentication small language model 124 to the state stored as the decrypted copy of the authentication small language model 124, as previously described in block 424 of FIG. 4. Once block 727 has completed, the sequence depicted in FIG. 7 can come to an end.

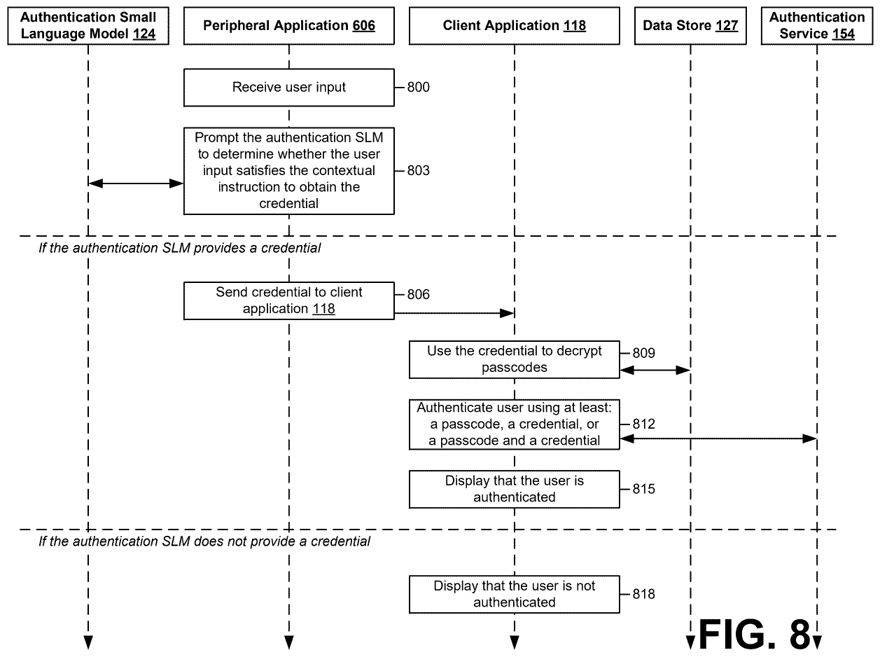

Moving on to FIG. 8, shown is a sequence diagram that provides at least one example of the interactions between the authentication small language model 124, the peripheral application 606, the client application 118, the data store 127, and the authentication service 154. The sequence diagram of FIG. 8 provides merely an example of the many different types of functional arrangements that can be employed by the authentication small language model 124, the peripheral application 606, the client application 118, the data store 127, and the authentication service 154. As an alternative, the sequence diagram of FIG. 8 can be viewed as depicting examples of elements of one or more method implemented within the network environment 600.

Beginning with block 800, the peripheral application 606 can receive user input. In some embodiments, the client device 103 can prompt the user to provide user input, as previously depicted in FIGS. 2A-2D. In various embodiments, the peripheral application 606 can receive the user input from the peripheral device 603. The user input can include text input, visual input, audio input, audio/visual input, or various other types of input.

Next, at block 803, the peripheral application 606 can prompt the authentication small language model 124 to determine whether the user input satisfies the contextual instruction 136A to obtain the credential 139A. For example, the authentication small language model 124 can include a contextual instruction 136 that indicates: “From now on, when I refer to the word ‘SHAZAM’, return the passcode ‘ASDAD#$F’.” In such an example, the peripheral application 606 can send a prompt along with the user input to the authentication small language model 124 that directs authentication small language model 124 to determine whether the contextual instruction 136A has been satisfied by the user input. In such an example where the user input is “SHAZAM”, the credential 139A “ASDAD#$F” would be returned by the authentication small language model 124. In such an example, if the user input is not “SHAZAM”, the authentication small language model 124 can return another response indicating that the credential 139A is not provided.

In yet another example, the authentication small language model 124 can be trained to accept a category of input, instead of a single word or phrase, to access the credential 139A. For example, the authentication small language model 124 can be configured with a credential 139A and/or a contextual instruction 136A that indicates: “From now on, when I discuss cheese, return the credential.” The authentication small language model 124 can be executed to parse the user input (e.g., text input, visual input, audio input, video input, combinations thereof, etc.) and provide a response based on the contextual instructions 136A. For example, a microphone or keyboard could capture the user input of the user stating, “Can you tell me about the waxy rind on Gouda” at block 800. To unwitting observers, this user input would seem innocuous. However, the authentication small language model 124 can interpret this input as satisfying the condition (e.g., discussing the specified category of input) to provide the credential 139A. In response, the authentication small language model 124 can then return the credential 139A for usage in the necessary environment. When the user input does not satisfy the contextual instruction 136A, the authentication small language model 124 can return another response indicating the credential 139A is not provided.

The sequence diagram of FIG. 8 proceeds to blocks 806, 809, 812, and 815 if the authentication small language model 124 provides a credential 139A as the response from block 803. Otherwise, the sequence diagram of FIG. 8 proceeds to block 818.

Next, at block 806, the peripheral application 606 can send the credential 139A to the client application 118. Next, at block 809, the client application 118 can use the credential 139 to decrypt the encrypted passcodes 148 to obtain the passcodes 151 from the data store 127 if the authentication small language model 124 provides a credential 139A as the response from block 803, as previously described at block 506 of FIG. 5. Continuing to block 812, the client application 118 can authenticate the client device 103 using at least one of: a passcode 151, the credential 139A, or both a passcode 151 and the credential 139A, as previously described at block 509 of FIG. 5. Next, at block 815, the client application 118 can display whether the user is authenticated with the authentication service 154 of the computing environment 106, as previously described at block 512 of FIG. 5. Continuing to block 818, the client application 118 can display that the user is not authenticated if the authentication small language model 124 fails to provide a credential 139A as the response from block 803, as previously described at block 515 of FIG. 5. Once block 818 has completed, the sequence depicted in FIG. 8 can come to an end.

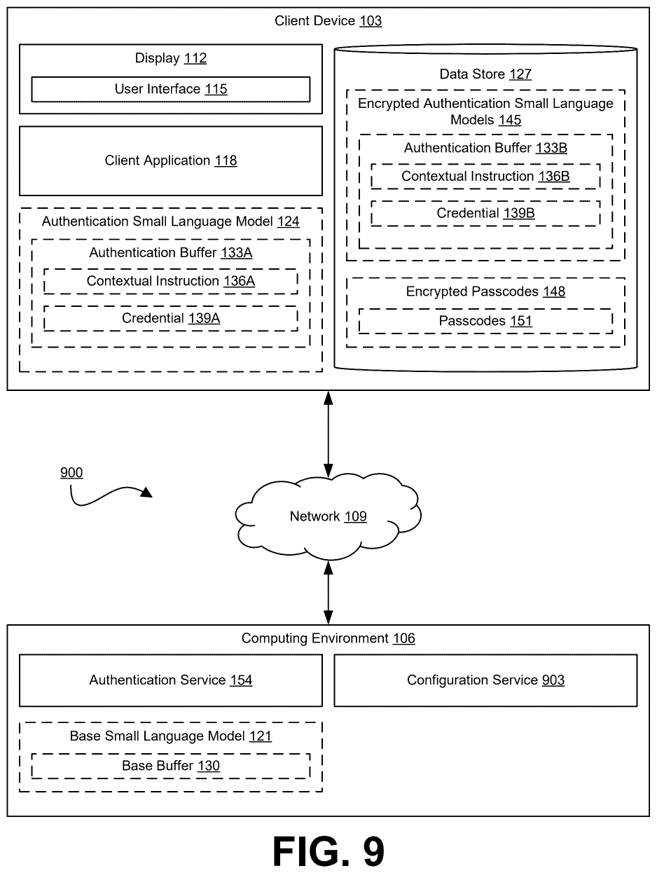

With reference to FIG. 9, shown is a network environment 900 according to various embodiments. The network environment 900 can include a client device 103, and a computing environment 106, which can be in data communication with each other via a network 109. The client device 103, the computing environment 106, and the network 109 of FIG. 9 are otherwise the same as the client device 103, the computing environment 106, and the network 109 of FIG. 1, except the client device 103 of FIG. 9 does not contain a base small language model 121. Instead, the computing environment 106 includes the base small language model 121, as previously described in FIG. 1. Further the computing environment 106 can further include a configuration service 903.

In embodiments such as those set forth in FIG. 9, the base small language model 121 could be deployed to the computing environment 106 in a variety of scenarios. For example, a cloud computing provider or software as a service (SaaS) provider could create and train the base small language model 121 and store it in the computing environment 106. The base small language model 121 could then be used by various client devices 103 to generate a local authentication small language model 124.

Various applications or other functionality can be executed in the computing environment 106. The components executed on the computing environment 106 include an authentication service 154 (as previously described in FIG. 1), and the configuration service 903, and other applications, services, processes, systems, engines, or functionality not discussed in detail herein.

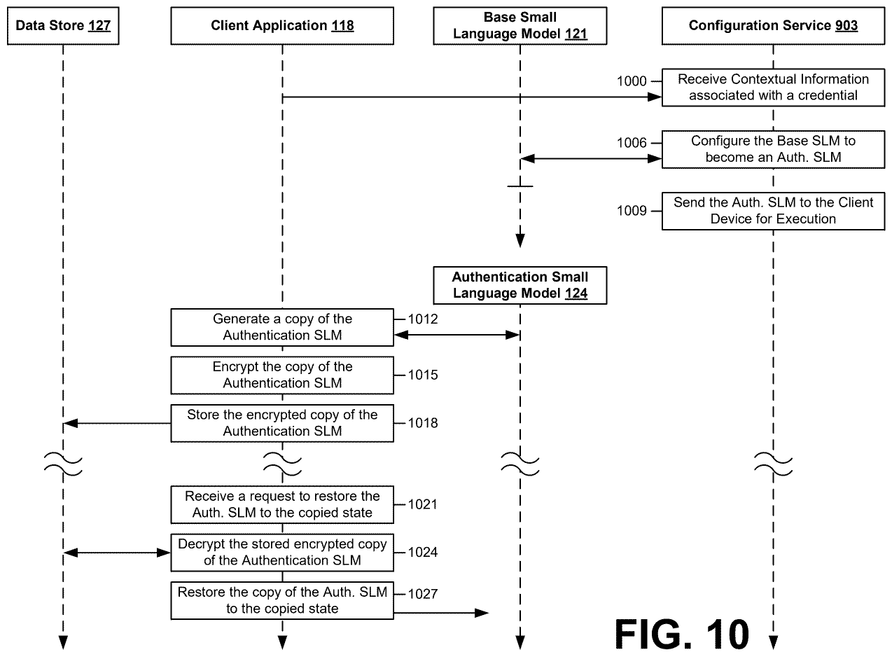

The training service can be executed to perform various functionality. For example, the configuration service 903 can receive contextual information (e.g., a contextual instruction 136, other request data, etc.) associated with a credential 139 from a user interface 115 or from the client application 118. The configuration service 903 can configure a base small language model 121 to become an authentication small language model 124 using at least the contextual information (e.g., contextual instruction 136, etc.) and the credential 139. Further discussion of the aforementioned functionality of the configuration service 903 is further described in the discussion of FIG. 10.

Referring next to FIG. 10, shown is a sequence diagram that provides at least one example of the interactions between the base small language model 121, the authentication small language model 124, the client application 118, the data store 127, the training data store 906 and the configuration service 903. The sequence diagram of FIG. 10 provides merely an example of the many different types of functional arrangements that can be employed by the base small language model 121, the authentication small language model 124, the client application 118, the data store 127, the training data store 906 and the configuration service 903. As an alternative, the sequence diagram of FIG. 10 can be viewed as depicting examples of elements of one or more method implemented within the network environment 900.

Beginning with block 1000, the configuration service 903 can receive contextual instructions 136 associated with a credential 139. In various embodiments of the present disclosure, the client application 118 can receive contextual instructions 136 as input from the client device 103. For example, the client application 118 can receive the contextual instructions 136 from a text input device (e.g., keyboard, digital keyboard, etc.), from an audio input device (e.g., microphone, etc.), from a video input device (e.g., video camera, night-vision camera, etc.), or any input mechanism on the client device 103. In at least some embodiments, the raw input from the aforementioned input devices can be interpreted or transformed into a contextual instruction 136. For example, the raw audio or raw video can be processed and interpreted to text to become contextual instructions 136. In various embodiments, the contextual instructions 136 can be associated with one or more credentials 139. The client application 118 can send then send the contextual instructions 136 to the configuration service 903.

In some embodiments, the configuration service 903 can receive the one or more credentials 139 along with the contextual instructions 136. For example, the configuration service 903 can receive a credential 139 (e.g., passcode, password, pin number, etc.) from the client application 118 having a text input device (e.g., keyboard, digital keyboard, etc.), from an audio input device (e.g., microphone, etc.), from a video input device (e.g., video camera, night-vision camera, etc.), or any input mechanism on the client device 103. In at least some embodiments, the raw input from the aforementioned input devices can be interpreted or transformed into a credential 139. In various embodiments, the credential 139 can already be stored on the configuration service 903. For example, a credential 139 can be stored on the configuration service 903 in the data store 127 or on the file system of the configuration service 903. In such embodiments, the contextual instructions 136 can indicate the association between the instruction and the credential 139, which did not necessarily need to be received because it was already on the computing environment 106.

Continuing to block 1006, the configuration service 903 can configure the base small language model 121 to become an authentication small language model 124. The configuration service 903 can configure the base small language model 121 in various different manners based on the architecture of the base small language model 121. For example, in at least one embodiment, the configuration service 903 can configure the base small language model 121 by providing a series of prompts that can include the contextual instructions 136 and the credentials 139. In some embodiments, the configuration service 903 can configure the base small language model 121 by providing the contextual instructions 136 and the credential 139, along with additional supporting language, as a prompt to configuration service 903; repeatedly ask for the base small language model 121 to provide the credential 139; and provide feedback to the base small language model 121 via a loss function. In some embodiments, the configuration service 903 can use optimization algorithms to optimize for specific results. In various embodiments, as the configuration service 903 is providing information (e.g., the contextual instructions 136, the credentials 139, etc.) to the base small language model 121, the base buffer 130 of the base small language model 121 will become filled with the information. In at least some embodiments, as the configuration service 903 is providing information to the base small language model 121, the base small language model 121 can condense the content within the base buffer 130, such that extraneous information is truncated while important information to perform the desired task (e.g., providing the credential 139 in response to the contextual instruction 136 being satisfied, etc.) will remain. The configuration service 903 can further fine tune a model by adjusting various parameters (e.g., learning rate, batch size, etc.) or further provide a more narrowly focused set of data to the base small language model 121. As the base buffer 130 of the base small language model 121 becomes filled with the contextual instruction 136 and/or credential 139, the base small language model 121 becomes an authentication small language model 124 having an authentication buffer 133A that contains the contextual instruction 136A and/or credential 139A.

Continuing to block 1009, the configuration service 903 can send the authentication small language model 124 to the client device 103 for execution. The configuration service 903 can send the authentication small language model 124 or a copy of the authentication small language model 124 to the client application 118. In at least some embodiments, the authentication small language model 124 can be exported as a deployable file (e.g., a deployment package, a docker container, etc.), which can act as a functional copy of the authentication small language model 124. The client application 118 can subsequently deploy the authentication small language model 124 to run on the client device 103.

Next, at block 1012, the client application 118 can generate a copy of the authentication small language model 124, as previously described in block 409 of FIG. 4. Continuing to block 1015, the client application 118 can encrypt the copy of the authentication small language model 124, as previously described in block 412 of FIG. 4. Next, at block 1018, the client application 118 can store the encrypted copy of the authentication small language model 124 as an encrypted authentication small language model 145 within the data store 127, as previously described in block 415 of FIG. 4. Continuing to block 1021, the client application 118 can receive a request to restore the authentication small language model 124 to the copied state stored as the encrypted authentication small language model 145, as previously described in block 418 of FIG. 4. Next, at block 1024, the client application 118 can decrypt the encrypted authentication small language model 145, which can be stored in the memory as a copy of the authentication small language model 124, as previously described in block 421 of FIG. 4. Continuing to block 1027, the client application 118 can restore authentication small language model 124 to the state stored as the decrypted copy of the authentication small language model 124, as previously described in block 424 of FIG. 4. Once block 1027 has completed, the sequence depicted in FIG. 10 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 106.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a contextual instruction associated with a credential, the contextual instruction representing a category of input;
train a small language model to generate an authentication small language model such that the authentication small language model returns the credential in response to determining that an input is within the category of input of the contextual instruction;
receive a client input; and
prompt the authentication small language model to make a determination regarding whether the client input is within the category of input of the contextual instruction.

2. The system of claim 1, wherein the machine-readable instructions that prompt the authentication small language model to make a determination regarding whether the client input is within the category of input of the contextual instruction further causes the computing device to at least prepend the client input to a buffer of the authentication small language model, the buffer being a predetermined size such that prepending the client input to the buffer causes a last input to be pushed out of the buffer of the authentication small language model.

3. The system of claim 2, wherein the last input is an input within a plurality of inputs of the buffer that includes returning the credential in response to determining that the input is within the category of input of the contextual instruction.

4. The system of claim 1, wherein the machine-readable instructions further cause the computing device to at least authenticate, in response to determining that the client input is within the category of input of the contextual instruction, a user account using the credential.

5. The system of claim 1, wherein the machine-readable instructions further cause the computing device to at least display a response indicating that the client input is not within the category of input of the contextual instruction.

6. The system of claim 1, wherein the machine-readable instructions further cause the computing device to at least:
copy the authentication small language model to generate a copy of the authentication small language model; and
encrypt the copy of the authentication small language model to generate an encrypted copy of the authentication small language model.

7. The system of claim 6, wherein the machine-readable instructions further cause the computing device to at least decrypt the encrypted copy of the authentication small language model to replace the authentication small language model.

8. A method, comprising:
receiving, by a computing device, a contextual instruction associated with a credential, the contextual instruction representing a category of input;
training, by the computing device, a small language model to generate an authentication small language model such that the authentication small language model returns the credential in response to determining that an input is within the category of input of the contextual instruction;
receiving, by the computing device, a client input; and
prompting, by the computing device, the authentication small language model to make a determination regarding whether the client input is within the category of input of the contextual instruction.

9. The method of claim 8, wherein prompting the authentication small language model to make a determination regarding the client input is within the category of input of the contextual instruction further comprises prepending, by the computing device, the client input to a buffer of the authentication small language model, the buffer being a predetermined size such that prepending the client input to the buffer causes a last input to be pushed out of the buffer of the authentication small language model.

10. The method of claim 9, wherein the last input is an input within a plurality of inputs of the buffer that includes returning the credential in response to determining that the input is within the category of input of the contextual instruction.

11. The method of claim 8, further comprising authenticating, in response to determining that the client input is within the category of input of the contextual instruction, a user account using the credential.

12. The method of claim 8, further comprising displaying a response indicating that the client input is not within the category of input of the contextual instruction.

13. The method of claim 8, further comprising:
copying, by the computing device, the authentication small language model to generate a copy of the authentication small language model; and
encrypting, by the computing device, the copy of the authentication small language model to generate an encrypted copy of the authentication small language model.

14. The method of claim 13, further comprising decrypting, the encrypted copy of the authentication small language model to replace the authentication small language model.

15. A non-transitory, computer-readable medium, comprising machine-readable instructions that, when executed by a processor of a computing device, cause the computing device to at least:
receive a contextual instruction associated with a credential, the contextual instruction representing a category of input;
configure a small language model to generate an authentication small language model such that the authentication small language model returns the credential in response to determining that an input is within the category of input of the contextual instruction;
receive a client input; and
prompt the authentication small language model to make a determination regarding the client input is within the category of input of the contextual instruction.

16. The non-transitory, computer-readable medium of claim 15, wherein the machine-readable instructions that prompt the authentication small language model to make a determination regarding the client input is within the category of input of the contextual instruction further causes the computing device to at least prepend the client input to a buffer of the authentication small language model, the buffer being a predetermined size such that prepending the client input to the buffer causes a last input to be pushed out of the buffer of the authentication small language model.

17. The non-transitory, computer-readable medium of claim 16, wherein the last input is an input within a plurality of inputs of the buffer that includes returning the credential in response to determining that the input is within the category of input of the contextual instruction.

18. The non-transitory, computer-readable medium of claim 15, wherein the machine-readable instructions further cause the computing device to at least send, in response to determining that the client input is within the category of input of the contextual instruction, the credential.

19. The non-transitory, computer-readable medium of claim 15, wherein the machine-readable instructions further cause the computing device to at least:
copy the authentication small language model to generate a copy of the authentication small language model; and
encrypt the copy of the authentication small language model to generate an encrypted copy of the authentication small language model.

20. The non-transitory, computer-readable medium of claim 19, wherein the machine-readable instructions further cause the computing device to at least decrypt the encrypted copy of the authentication small language model to replace the authentication small language model.
